(19) United States
(12) Patent Application Publication
(10) Pub. No.: US 2004/0054796 A1
(43) Pub. Date: Mar. 18, 2004

(54) Load balancer

(76) Inventors: Shunsuke Kikuchi, Kawasaki (JP); Jun Ogawa, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/640,144

(22) Filed: Aug. 13, 2003

(30) Foreign Application Priority Data
Aug. 30, 2002 (JP) 2002-254233

(51) Int. Cl. G06F 15/16

(52) U.S. Cl. 709/229; 709/230

(57) ABSTRACT

A load balancer includes a judging module judging based on a content of data received from a client whether or not an acknowledgement of the data is to be sent to the client, an acknowledging module sending the acknowledgement to the client in accordance with a result of the judgment by the judging module, a forwarding module forwarding the data received from the client to any of a plurality of servers, and a retransmission data storage module storing only the data the acknowledgement of which is sent to the client among data forwarded to the server in preparation for a retransmission to the server.

### FIELD OF INVENTION

The present invention relates to a load balancer constructed to make a plurality of servers operate as if one single server operates, virtually.

### BACKGROUND OF THE INVENTION

In the case of transmitting and receiving data between arbitrary terminals, a retransmission management is carried out for ensuring an arrival of the data. A source terminal for performing the retransmission management has a transmission buffer and stores in the transmission buffer the data transmitted to a destination terminal. Then, in the case of detecting that the data are abnormal and dropped, the source terminal retransmits the data stored in the transmission buffer to the destination terminal. The destination terminal, when correctly receiving the data transmitted from the source terminal, returns acknowledgement data to the source terminal. The source terminal, when receiving the acknowledgement data from the destination terminal, deletes the data stored in the transmission buffer, thus releasing the transmission buffer. TCP (Transmission Control Protocol) is an example of a protocol on which the retransmission management described above is conducted based.

The retransmission management given above is performed also in the load balancer. The load balancer is a device for allocating requests from the clients to the plurality of servers. The use of the load balancer avoids the client requests from concentrating on a specified server.

A memory area structuring the transmission buffer may be defined as a resource finite to the load balancer. The resource can be effectively utilized by reducing an activity time (a hold time) of the transmission buffer in one session. The effective utilization of the resource is exemplified such as improving a multiplexing degree of the session, decreasing a consumption of electricity and so on.

There has hitherto been a technique by which the TCP-based load balancer reduces the activity time of the transmission buffer by deleting the data from the transmission buffer at an early stage in a way that omits the retransmission management. According to this technique, the load balancer, when omitting the retransmission management, assigns the server or the client the retransmission management essentially required to execute. In this case, the load balancer, when receiving a response from the server, does not return Ack (acknowledgement) to the server. The load balancer transfers the response received from the server to the client, and deletes the response stored in the transmission buffer.

FIGS. 1(a) to 1(c) are diagrams each showing operation sequences of a client P2, a load balancer P3 and a server P4 in a case where the load balancer P3 in the related art omits the retransmission management. Operations of the client P2, the load balancer P3 and the server P4 in the case where the retransmission management is omitted in the load balancer P3, will be explained referring to FIGS. 1(a) to 1(c).

Given is a description of a case in which the server P4 normally forwards the data to the client P2 (see FIG. 1(a)). To start with, the server P4 sends the response to the load balancer P3. The load balancer P3 transfers the response to the client P2. The client P2 receives the response and returns Ack to the load balancer P3. The load balancer P3 transfers Ack to the server P4. Then, the server P4 receives a packet containing Ack (which is called an Ack packet) from the load balancer P3. With these operations, the server P4 confirms that the client P2 normally received the data.

Given next is an explanation of a case where the data is dropped between the server P4 and the load balancer P3 (see FIG. 1(b)). At first, the server P4 sends a response to the load balancer P3. At this time, an assumption is that the data is dropped. In this case, the load balancer P3 receives nothing and executes none of processes. Then, the server P4 is unable to, even when waiting till an elapse of time-out seconds, receive Ack from the load balancer P3 and therefore resends the response.

Next, a case where the packet is dropped between the load balancer P3 and the client P2 (see FIG. 1(c)) will be described. To begin with, the server P4 sends the response to the load balancer P3. The load balancer P3 transfers the received response to the client P2. At this time, the assumption is that the data is dropped. In this case, the client P2 receives nothing and executes none of the processes. Then, the server P4 is unable to, even when waiting till an elapse of time-out seconds, receive Ack form the load balancer P3 and therefore resends the response to the load balancer P3.

### SUMMARY OF THE INVENTION

According to the technique described above, the retransmission management is omitted in the load balancer about the response received from the server. Herein, the load balancer can further reduce the activity time of the transmission buffer by omitting the retransmission management also about a request received from the client.

If the client utilizes a slow start mechanism in the data transmission, however, the load balancer cannot omit the retransmission management with respect to the request received from the client.

FIGS. 2(a) and 2(b) are diagrams each showing the slow start mechanism. The slow start mechanism will be discussed with reference to FIGS. 2(a) and 2(b). When a transmission terminal (the client) using the slow start mechanism transmits the data to a receiving terminal (the load balancer), the transmission terminal exponentially increments, from “1”, a data count (a simultaneous transmission data count) of pieces of data that are simultaneously transmitted (see FIG. 2(a)). At this time, the transmission terminal is in a standby status for transmitting the next data till it receives Ack to the previous data from the receiving terminal.

It is assumed that the client P2 transmits the data to the load balancer P3 by utilizing the slow start mechanism. At this time, if the request is structured of the single data, the load balancer P3 can extract a URL (Uniform Resource Locator) in the received data, then determine an allocating destination and execute a forwarding process to the server P4 determined. Accordingly, the client P2 finally can receive the response via the load balancer P3 from the server P4.

On the other hand, if the request is structured in a way that divides it into plural pieces of data, the client P2, each time the client P2 transmits one or more pieces of data structuring the request, comes to the standby status for receiving Ack corresponding to the same transmitted data (see FIG. 2(b)). In FIG. 2(b), one request is divided into data Dc and data Dd. Then, the client P2 does not send the data Dd till the client P2 receives Ack to the data Dc from the load balancer P3.

Herein, if the load balancer P3 omits the retransmission management about the request received from the client P2, the client P2 is unable to receive Ack to the transmitted data Dc from the load balancer P3. Therefore, the client P2 repeats retransmitting the data Dc to the load balancer P3. Even when repeating the retransmission, the load balancer P3 does not send Ack to the client P2. As a result, the load balancer P3 is unable to receive the data Dd and cannot therefore receive the request completely. Consequently, the load balancer P3 cannot extract the URL and is therefore unable to execute the determination of the allocating destination of the request. Accordingly, the load balancer P3 cannot transfer the request received from the client P2 to the server P4, with the result that the data transmission and receipt are hanged up on the whole.

The load balancer P3 returns Ack to the client P2 with respect to the request received from the client P2 irrespective of a content of this request in order to avoid load balancer P3 itself from being unable to receive the request. In this case, the load balancer P3 needs to perform the retransmission management about the request received from the client P2. Namely, the load balancer P3 is required to store the transmission buffer with the request received from the client P2 till Ack to the request is received from the server P4.

FIGS. 3(a) and 3(b) are diagrams each showing an operation sequence of the load sharing system using the load balancer in the related art. A problem arising in a case where the load balancer P3 returns Ack to the request received from the client P2 and nevertheless the request is not stored in the transmission buffer, will be elucidated referring to FIGS. 3(a) and 3(b). This problem does not occur when the server P4 normally receives the request transferred to the server P4 from the load balancer P3 (see FIG. 3(a)).

While on the other hand, if the request transferred to the server P4 from the load balancer P3 is dropped before the server P4 receives it (see FIG. 3(b)), the following problem might arise. Namely, the load balancer P3 does not store the request in the transmission buffer and is therefore unable to retransmit the request to the server P4. On the other hand, the client P2 deletes the request from the transmission buffer just when receiving Ack from the load balancer P3. Therefore, the client P2 cannot retransmit the request to the load balancer P3.

Accordingly, the load balancer P3 must store the transmission buffer with the request without deleting it till the load balancer P3 receives Ack from the server P4 in preparation for the dropout of the request. Thus, the load balancer P3 in the related art cannot omit the retransmission management about the request received from the client P2. The load balancer P3 in the related art is therefore incapable of reducing the activity time of the transmission buffer.

### SUMMARY OF THE INVENTION

It is a primary object of the present invention, which was devised to obviate the problems described above, to provide a load balancer capable of reducing an activity time of a transmission buffer by omitting a retransmission management about a request received from a client.

To accomplish the above object, a load balancer according to a first aspect of the present invention includes a judging module (unit) judging based on a content of data received from a client whether or not an acknowledgement of the same data is to be sent to the client, an acknowledging module sending the acknowledgement to the client in accordance with a result of the judgment by the judging module, a forwarding module forwarding the data received from the client to any one of a plurality of servers, and a retransmission data storage module storing only the data (piece(s) of data)the acknowledgement of which is sent to the client among pieces of data forwarded to the server in preparation for a retransmission to the server.

According to the first aspect of the present invention, the judging module analyzes a content of the data received from the client, and thus judges from this data content whether or not an acknowledgement is returned to the client. This acknowledgement is an acknowledgement to the data received from the client. When the judging module executes judging as described above, the acknowledging module returns the acknowledgement to the client on the basis of a result of this judgment. The forwarding module forwards the data received from the client to any one of a plurality of servers. The retransmission data storage module is used to store the data forwarded to the server in preparation for retransmitting the data to the server.

Therefore, the retransmission data storage module is not used to store the data about which the acknowledgement is not returned to the client. Hence, to use the retransmission data storage module is not necessarily to store all the data forwarded to the server, resulting in a reduction in an active storage area.

The judging module in the thus constructed load balancer according to the first aspect of the invention may judge, if the data received from the client does not contain a delimiter, that the acknowledgement is sent to the client and may judge, if the data contains the delimiter, that the acknowledgement is not set to the client.

According to the first aspect of the invention having the architecture described above, the judging module judges, based on whether the data received from the client contains the delimiter or not, whether the acknowledgement to the data is sent to the client. Then, the acknowledging module, when receiving the data containing no delimiter, sends the acknowledgement to the same data to the client.

Therefore, even when the client adopts a slow start mechanism, the load balancer can receive the data next to the data containing no delimiter from the client.

Further, the thus constructed load balancer according to the first aspect of the invention may further include an acknowledgement judging module enabling a next piece of data to be forwarded to the server when receiving from the server an acknowledgement to the data forwarded finally to the server in the case of forwarding consecutive pieces of data to the server.

The thus constructed load balancer according to the first aspect of the invention may further include forwarding judging module judging whether or not the data received from the server should be forwarded to the client.

In the load balancer according to the first aspect of the invention, the forwarding judging module may judge, if the data received from the server is structured of only data for the acknowledgement, that the data should not be forwarded.

In the load balancer according to the first aspect of the invention, the judging module may judge, if the data received from the client is an HTTP request structured of one packet, that the acknowledgement is not sent.

In the load balancer according to the first aspect of the invention, the judging module may judge, if the data received from the client is an HTTP request structured of a plurality of packets, that the acknowledgements are sent when receiving packets except for the last packet that structures this HTTP request.

According to the present invention, the data forwarded to the server from the client is deleted from the transmission buffer at an early stage, whereby an activity time of the transmission buffer can be reduced.

### BRIEF DESCRIPTION OF THE DRAWINGS

FIGS. 1(a) to 1(c) are diagrams each showing an operation sequence in a case of omitting a retransmission management in the related art;

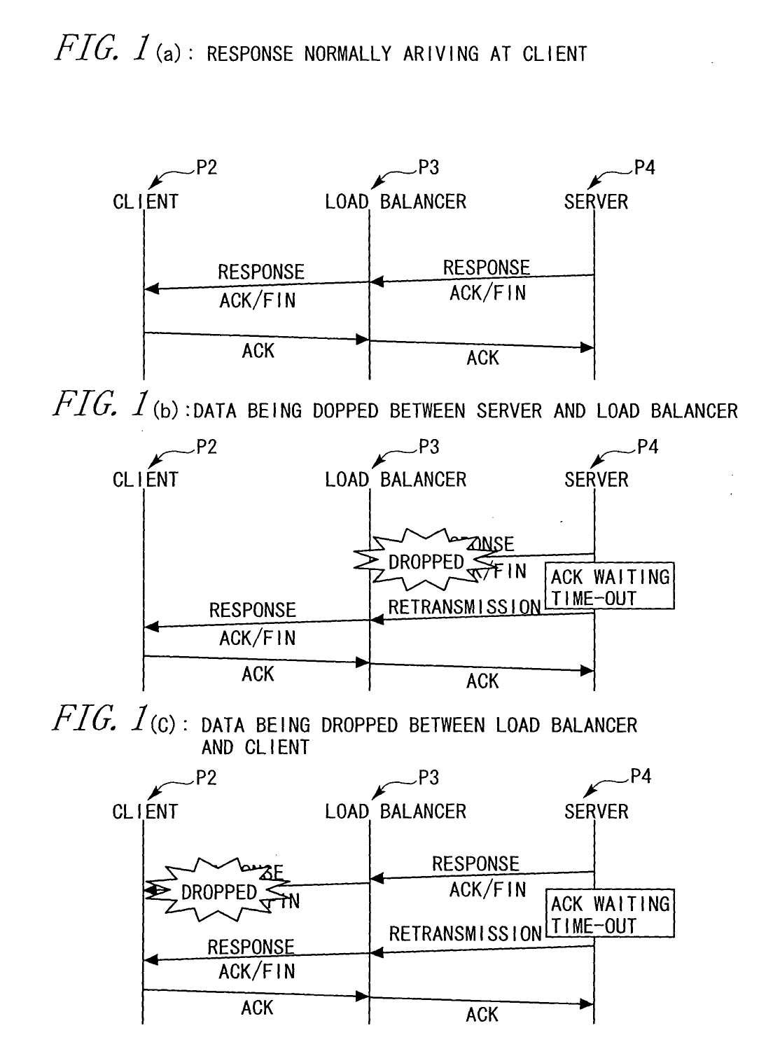

FIGS. 2(a) and 2 (b) are diagrams each showing a slow start mechanism;

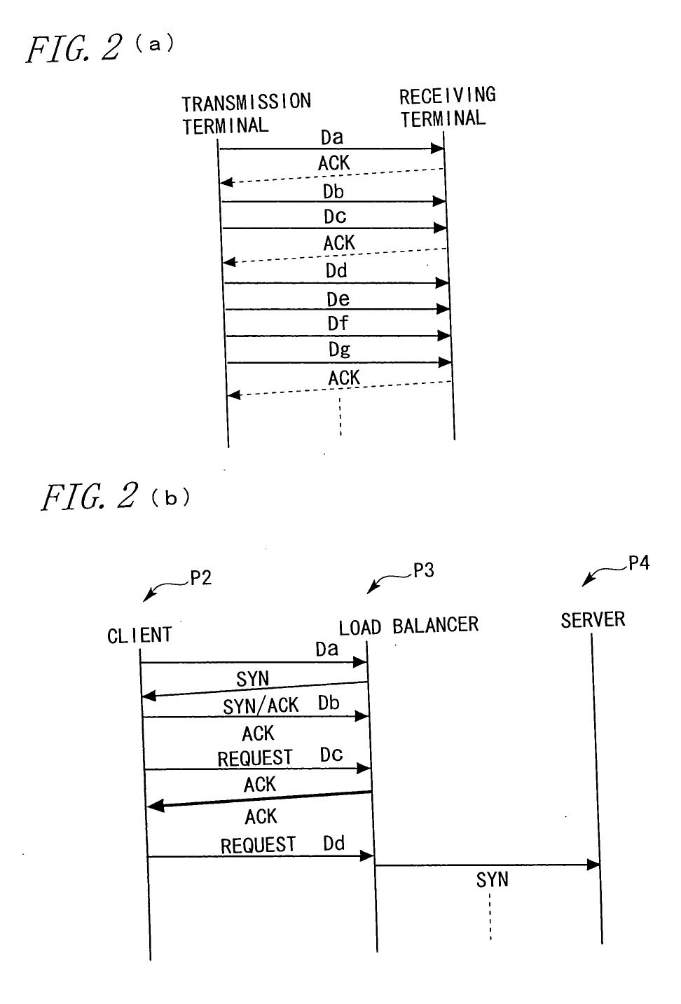

FIGS. 3(a) and 3 (b) is a diagram showing an operation sequence of a load sharing system using a load balancer in the related art;

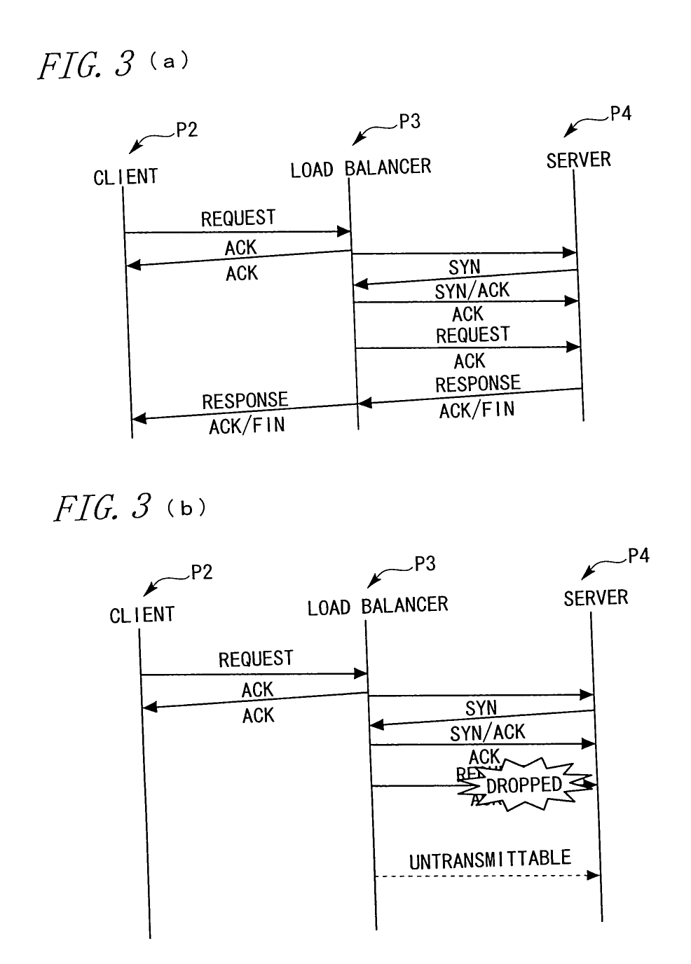

FIG. 4 is a view showing an outline of a load sharing system;

FIG. 5 is a block diagram of a load balancer in a first embodiment;

FIG. 6 is a flowchart showing an operational example of the load balancer in the first embodiment;

FIG. 7 is a flowchart showing an operational example of the load balancer in the first embodiment;

FIG. 8 is a flowchart showing an operational example of the load balancer in the first embodiment;

FIGS. 9(a) and 9(b) are diagrams each showing an operation sequence of the load sharing system using the load balancer in the first embodiment;

FIG. 10 is a diagram showing an operation sequence of the load sharing system using the load balancer in the first embodiment;

FIGS. 11(a) and 11(b) are diagrams each showing an operation sequence of the load sharing system using the load balancer in the first embodiment;

FIGS. 12(a) and 12(b) are diagrams each showing a timing at which a storage area on the load balancer is released;

FIG. 13 is a block diagram of the load balancer in a second embodiment;

FIG. 14 is a flowchart showing an operational example of the load balancer in the second embodiment;

FIG. 15 is a diagram showing an operation sequence of the load sharing system using the load balancer in the second embodiment;

FIGS. 16(a) and 16(b) are diagram showing a difference in operation between the load balancer in the related art in FIG. 16(a) and the load balancer in the second embodiment in FIG. 16(b);

FIG. 17 is a block diagram of the load balancer in a third embodiment;

FIG. 18 is a flowchart showing an operational example of the load balancer in the third embodiment;

FIG. 19 is a diagram showing an operation sequence of the load sharing system using the load balancer in the third embodiment; and

FIGS. 20(a) and 20(b) are diagrams showing a difference in operation between the load balancer in the related art in FIG. 20(a) and the load balancer in the third embodiment in FIG. 20(b).

### DETAILED DESCRIPTION OF THE PREFERRED EMBODIMENTS

Next, a load sharing system involving the use of a load balancer in embodiments of the present invention will hereinafter be described with reference to the accompanying drawings. Note the explanations of the embodiments are exemplifications, and the present invention is not limited to architectures given in the following discussions.

### FIRST EMBODIMENT

<System Architecture>

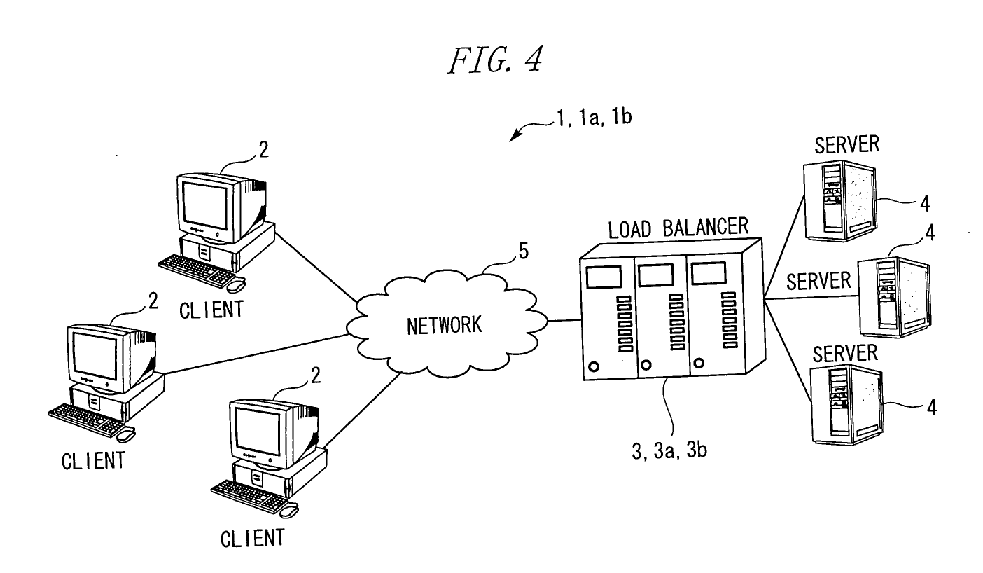

FIG. 4 is a view showing an outline of a load sharing system 1. The load sharing system 1 using a load balancer 3 in the first embodiment is built up by use of a plurality of clients 2, the load balancer, a plurality of servers, and a network 5 through which the plurality of clients 2 are connected communicably to the load balancer 3. The load balancer 3 in the first embodiment handles, by way of an example, HTTP (HyperText Transfer Protocol) (that sets up a communication between the server 4 and the client 2) in a way that uses TCP/IP (Transmission Control Protocol/Internet Protocol). The client 2 and the server 4 handle (communication information based on) HTTP by use of, at least, TCP/IP. It is sufficient that the load balancer 3 is a device handling the protocol designed for sending acknowledgement (ACK) but is not limited to the device handling TCP/IP. The following is an explanation of each of the components of the load sharing system 1.

<<Client>>

The client 2 is constructed of an information-processing device such as a personal computer, a workstation, etc.. The client 2 is so configured by use of a communication device such as a network card, etc. as to be communicable with the load balancer 3 via the network 5. The client, into which Browser software is installed, sends a packet containing an HTTP request to the load balancer 3. Then, the client 2 receives a packet containing an HTTP response to this HTTP request. The browser displays a content of the received HTTP on the client 2. Further, the client 2 sends the packet on the basis of a slow start mechanism.

<<Load Balancer>>

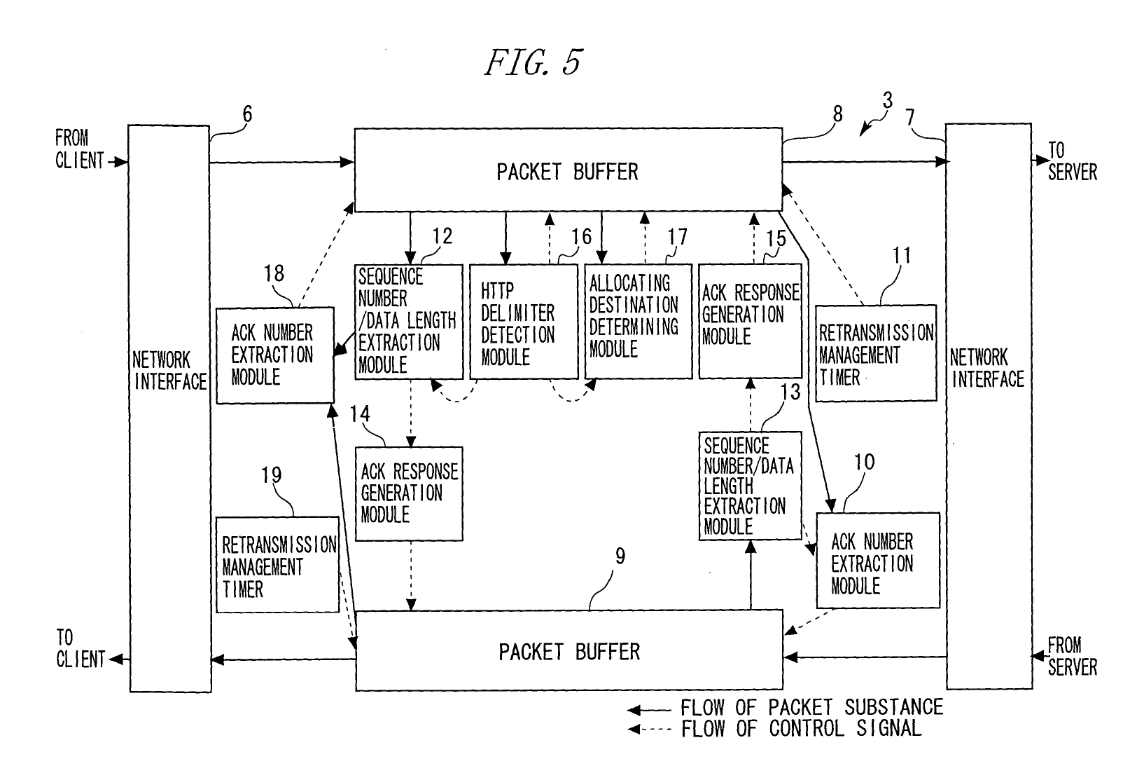

The load balancer 3 is constructed of an information-processing device such as a personal computer, a workstation and so on. FIG. 5 is a block diagram showing the load balancer 3. The load balancer 3 will be explained referring to FIG. 5. The load balancer 3 includes, as hardware components, a CPU, a main memory (RAM), a sub-storage device (a hard disk), a communication control device (a network card, etc.) and soon, which are connected to each other via a bus. The load balancer 3, when a variety of programs (OS, application software, etc.) stored on the sub-storage device are loaded into the main memory and executed by the CPU, functions as a device including network interfaces 6, 7, packet buffers 8, 9, Ack number extraction modules (units) 10, 18, retransmission management timers 11, 19, sequence number/data length extraction modules 12, 13, Ack generation modules 14, 15, an HTTP delimiter detection module 16 and an allocating destination determining module 17.

The network interfaces 6, 7 are structured by use of network cards, etc.. The network interface 6 receives the packet transmitted from the client 2 via the network 5, and writes the same packet to the packet buffer 8. Further, the network interface 6 sends the packet received from the packet buffer 9 to the client 2 via the network 5. The network interface 7 receives the packet transmitted from the server 4 and writes the packet to the packet buffer 9. Moreover, the network interface 7 sends the packet received from the packet buffer 8 to the server 4.

The packet buffers 8, 9 are constructed of CPUs, RAMs and so forth. The packet buffer 8, upon receiving an delete signal from the retransmission management timer 11, deletes the packet mapping to an identifier contained in this delete signal. The packet buffer 8, when receiving a retransmission signal from the retransmission management timer 11, transmits the packet mapping to an identifier contained in this retransmission signal to the network interface 7. The packet buffer 8 buffers the packet transmitted from the client 2 or generated by the load balancer 3. Then, the packet buffer 8 sends the packet buffered therein to the network interface 7. Further, the packet buffer 8, when the Ack generation module 15 generates a packet and buffers it in the packet buffer 8, sends this packet to the network interface 7. Moreover, the packet buffer 8, upon receiving an delete signal from the allocating destination determining module 17, confirms that the packet mapping to an identifier contained in this delete signal has been forwarded, deletes this packet.

The packet buffer 9, upon receiving an delete signal from the retransmission management timer 19, deletes the packet mapping to an identifier contained in this delete signal. The packet buffer 9, when receiving a retransmission signal from the retransmission management timer 19, transmits the packet mapping to an identifier contained in this retransmission signal to the network interface 6. The packet buffer 9 buffers the packet transmitted from the server 4 or generated by the load balancer 3. Then, the packet buffer 9 sends the packet buffered therein to the network interface 6. Further, the packet buffer 9, when the Ack generation module 14 generates a packet and buffers it in the packet buffer 9, sends this packet to the network interface 6.

The Ack number extraction modules 10, 18 are constructed of CPUs, RAMs and so on. The Ack number extraction module 10 extracts an Ack number of the packet buffered in the packet buffer 8. Further, the Ack number extraction module 10 receives a sequence number and a data length from a sequence number/data length extraction module 13. Namely, the Ack number extraction module 10 receives a sequence number and a data length of the packet buffered in the packet buffer 9. Then, the Ack number extraction module 10 compares a value of the Ack number with a sum of values of the sequence number and the data length. The Ack number extraction module 10, if the value of the Ack number is larger than or equal to the sum, transmits to the packet buffer 9 an delete signal containing an identifier of the packet that includes the above sequence number and the data length. The delete signal contains the identifier of the packet that should be deleted.

The Ack number extraction module 18 extracts the Ack number of the packet buffered in the packet buffer 9. Further, the Ack number extraction module 18 receives the sequence number and the data length from the sequence number/data length extraction module 12. Namely, the Ack number extraction module 18 receives the sequence number and the data length of the packet buffered in the packet buffer 8. Then, the Ack number extraction module 18 compares a value of the Ack number with an added value of the sequence number and the data length. The Ack number extraction module 18, of the value of the Ack number is larger than or equal to the added value, transmits an delete signal to the packet buffer 8. The delete signal contains an identifier of the packet that should be deleted.

The retransmission management timers 11, 19 are constructed of clocks, CPUs, etc.. The retransmission management timer 11 measures a time elapsed since the network interface 7 has sent the packet buffered in the packet buffer 8. The retransmission management timer 11, if there is a packet with an elapse of a fixed or longer period of time since the packet transmission (time-out), transmits a retransmission signal containing an identifier of this time-out packet to the packet buffer 8.

The retransmission management timer 19 measures a time elapsed since the network interface 6 has sent the packet buffered in the packet buffer 9. The retransmission management timer 19, if there is a packet with an elapse of a fixed or longer period of time since the packet transmission, transmits a retransmission signal containing an identifier of this time-out packet to the packet buffer 9.

The sequence number/data length extraction modules 12, 13 are constructed of CPUs, RAMs, etc.. The sequence number/data length extraction module 12 extracts a sequence number and a data length of the packet buffered in the packet buffer 8. Then, the sequence number/data length extraction module 12 transmits the sequence number and the data length to the Ack generation module 14 and the Ack number extraction module 18.

The sequence number/data length extraction module 13 extracts a sequence number and a data length of the packet buffered in the packet buffer 9. Then, the sequence number/data length extraction module 13 transmits the sequence number and the data length to the Ack generation module 15 and the Ack number extraction module 10.

The Ack generation modules 14, 15 are constructed of CPUs, RAMs, etc.. The Ack generation module 14 generates a packet having, as an Ack number, the sum of the two values received from the sequence number/data length extraction module 12. Then, the Ack generation module 14 buffers the generated packet in the packet buffer 9.

The Ack generation module 15 generates a packet having, as an Ack number, the sum of the two values received from the sequence number/data length extraction module 13. Then, the Ack generation module 15 buffers the generated packet in the packet buffer 8.

The HTTP delimiter detection module 16 is constructed of a CPU, a RAM, etc.. The HTTP delimiter detection module 16 judges whether or not a payload of a packet (a request packet) containing an HTTP request that is to be buffered in the packet buffer 8 contains an HTTP delimiter (e.g., a null line). The HTTP delimiter detection module 16, if the payload contains the delimiter, transmits a forwarding signal to the allocating destination determining module 17. This forwarding signal contains an identifier of the request packet of which the delimiter is detected by the HTTP delimiter detection module 16.

Further, the HTTP delimiter detection module 16, if the request packet does not contain the delimiter, instructs the sequence number/data length extraction module 12 to executes a process of transmitting a packet containing Ack (an Ack packet) to the client 2.

The allocating destination determining module 17 is constructed of a CPU, a RAM, etc.. The allocating destination determination module 17 extracts a URL (Uniform Resource Locator) contained in the request packet, and selects an optimal server 4 having a content specified by the URL. Further, the allocating destination determination module 17, upon receiving a forwarding signal from the HTTP delimiter detection module 16, forwards to the selected server 4 the request packet mapping to the identifier contained in the forwarding signal. To be specific, the allocating destination determination module 17 rewrites pieces of information such as a destination address, a source address, etc., of the forwarding target request packet, and forwards this request packet to the server 4. Further, the allocating destination determination module 17 transmits to the packet buffer 8 an delete signal containing an identifier of the request packet having the delimiter.

Note that the Ack number extraction modules 10, 18, the sequence number/data length extraction modules 12, 13, the HTTP delimiter detection module, the allocating destination determination module 17 and the Ack generation modules 14, 15 operate not independently but in a packet arriving sequence. Moreover, the required processes other than those related to the receipt and transmission of the packet, are the processes that have hitherto been executed, and therefore the explanations thereof are omitted.

<<Server>>

Referring back to FIG. 4, the server 4 is constructed of the information-processing device such as the personal computer, the workstation, etc.. The server 4 is so structured as to be communicable with the load balancer 3 by use of the communication device such as the network card, etc.. HTTPD (HTTP Daemon) is executed in the server 4. The server 4 returns a packet containing an HTTP response (which is called a response packet) to the request packet received from the load balancer 3.

<Operational Example>

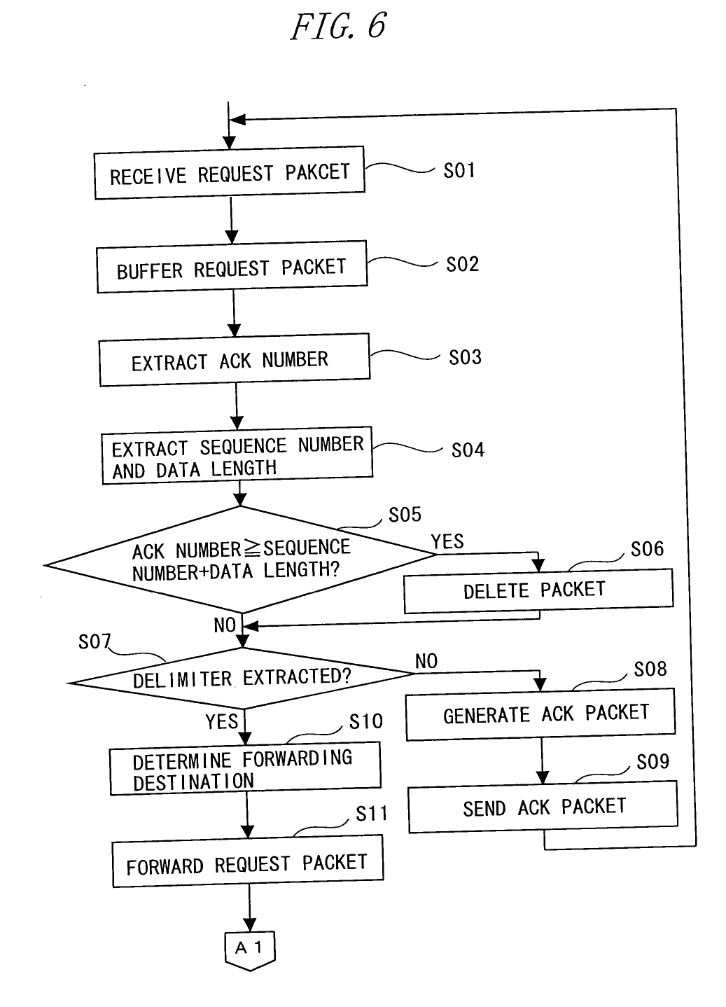

FIGS. 6 through 8 are flowcharts showing an operational example of the load balancer 3. The operational example of the load balancer 3 will be described with reference to FIGS. 5 and 6 through 8. The discussion herein is based on the assumption that the load balancer 3 receives the request packet from the client 2 and received the response packet from the server 4.

The network interface 6 of the load balancer 3 receives the request packet from the client 2 (see FIG. 6: S01). The packet buffer 8 buffers the request packet received (S02). The Ack number extraction module 10 extracts an Ack number from this request packet (S03). Further, the sequence number/data length extraction module 13 extracts and transmits a sequence number and a data length of the packet buffered in the packet buffer 9 to the Ack number extraction module 10 (S04). The Ack number extraction module 10 compares the extracted Ack number with a sum of the values of the sequence number and the data length (S05). If the packet of which the sum of the values of the sequence number and the data length is smaller than the Ack number is buffered in the packet buffer 9 (S05-YES), the packet buffer 9 deletes this packet (S06).

Next, the HTTP delimiter detection module 16 judges whether the request packet buffered in the packet buffer 8 contains a delimiter or not (S07). If the HTTP delimiter detection module 16 does not detect the delimiter (S07-NO) the sequence number/data length extraction module 12 transmits the extracted sequence number and data length to the Ack generation module 14. The Ack generation module 14 adds the received sequence number and data length. Then, the Ack generation module 14 generates a packet having this value as an Ack number and buffers this packet in the packet buffer 9 (S08). The packet buffer 9 transmits the buffered packet to the client 2 via the network interface 6 (S09). Thereafter, the load balancer 3, when receiving a new request packet from the client 2, executes afresh the processes in S01 through S07.

On the other hand, the HTTP delimiter detection module 16, when detecting the delimiter (S07-YES), transmits a forwarding signal to the allocating destination determining module 17. The allocating destination determining module 17 reads information from a payload field of the request packet in the packet buffer 8, and determines a proper server 4 having a content specified by a URL indicated therein (S10). The allocating destination determining module 17, when a TCP connection to the determined server 4 is opened, forwards all the request packets to the server 4 (S11). A this time, the allocating destination determining module 17 transmits to the packet buffer 8 an delete signal containing an identifier of the request packet having a delimiter among the forwarding target request packets. Then, the packet buffer 8 deletes this request packet.

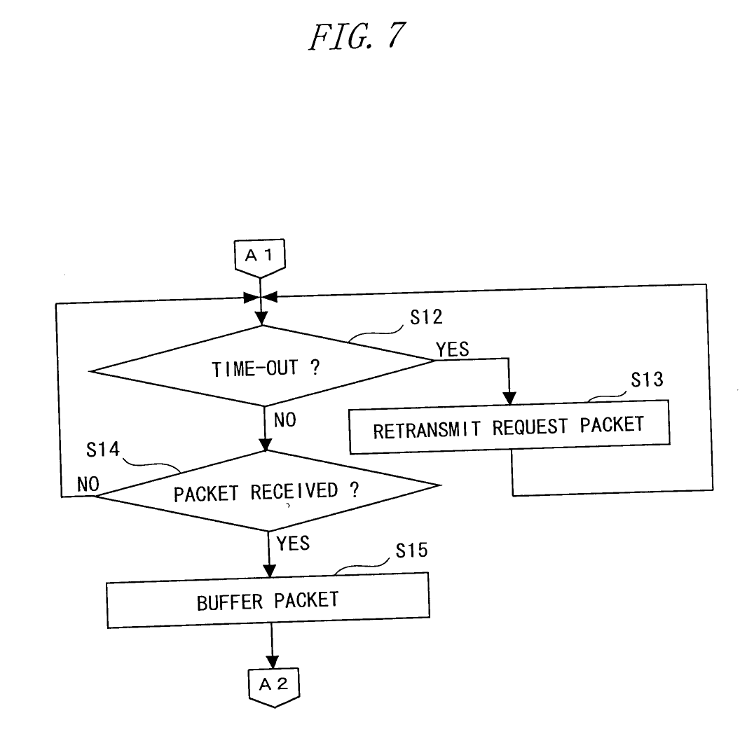

The retransmission management timer 11, if there is a time-out request packet (see FIG. 7: S12-Yes), transmits a retransmission signal containing an identifier of this time-out request packet to he packet buffer 8. Then, the packet buffer 8 retransmits the request packet specified by an identifier contained in this retransmission signal to the server 4 (S13).

Whereas if there is no time-out request packet (S12-No), it is judged whether or not the network interface 7 receives the packet from the server 4 (S14). If the network interface 7 does not receive the packet (S14-No), the processing returns again to the time-out judging step. Whereas if the network interface 7 has received the packet (S14-Yes), the packet buffer 9 buffers this packet (S15).

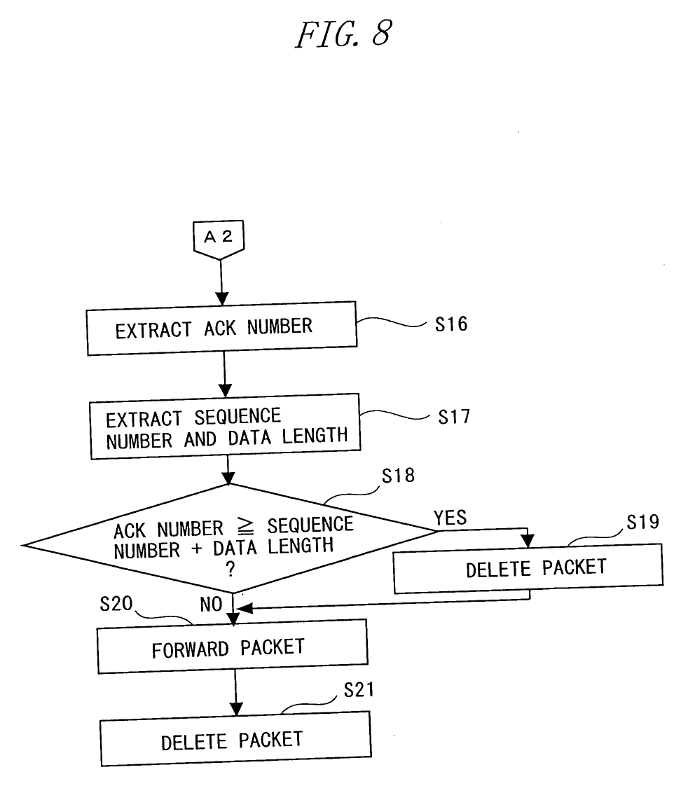

After the packet buffer 9 has buffered the packet, the Ack number extraction module 18 extracts an Ack number of the buffered packet (see FIG. 8: S16). Further, the sequence number/data length extraction module 12 extracts and transmits a sequence number and a data length of the packet buffered in the packet buffer 8 to the Ack number extraction module 18 (S17). The Ack number extraction module 18 judges whether there is a packet of which a sum of values of the sequence number and the data length is equal to or smaller than a value of the extracted Ack number (S18). If such a packet is buffered in the packet buffer 8 (S18-Yes), the packet buffer 8 deletes this packet (S19).

The packet buffer 9 forwards the buffered packet (received from the server 4) to the client 2 (S20). Then, the packet buffer 9 deletes the forwarded packet (S21).

<Operation Sequence>

Next, an operation sequence of the load sharing system 1 in the first embodiment will be discussed.

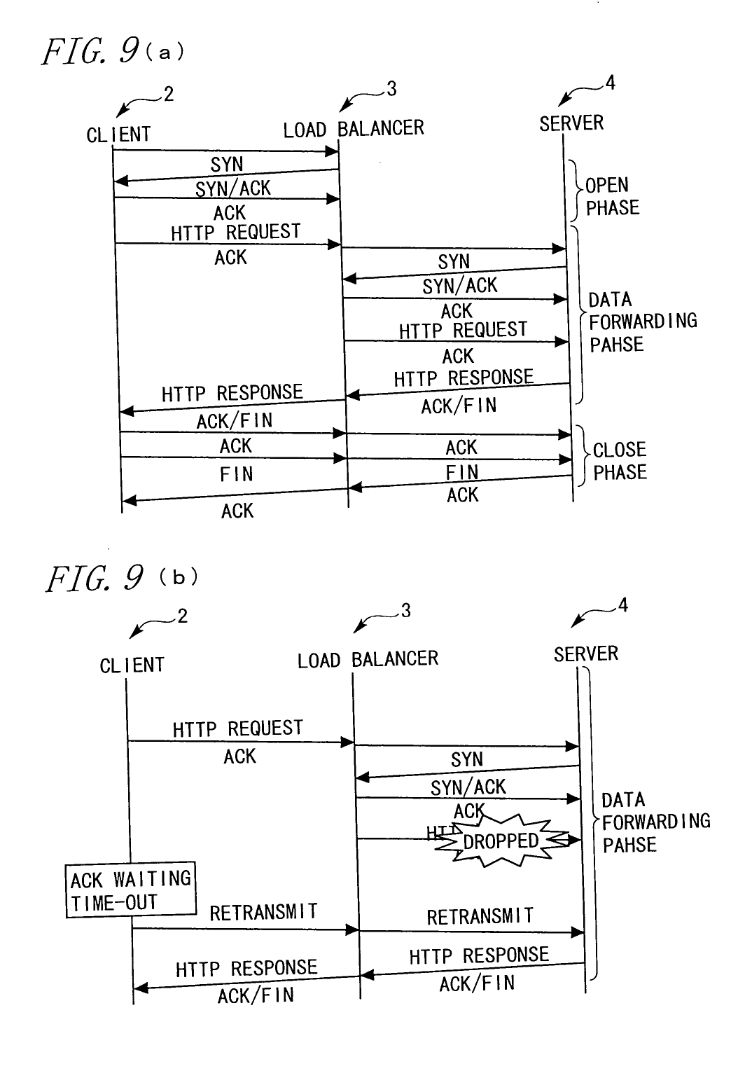

FIGS. 9(a) and 9(b) are diagrams each showing the operation sequence of the load sharing system 1 in a case where the HTTP request is structured of one single request packet. Firstly, an operation sequence in a case in which the HTTP request is structured of one single request packet that is not dropped, will be explained with reference to FIG. 9(a).

To start with, the client 2 and the load balancer 3 set the TCP connection open (open phase: see FIG. 9(a)). The client 2, after the connection has become open, sends the request packet (containing the HTTP request) to the load balancer 3 by way of a data transfer phase process.

The load balancer 3 receives the request packet from the client 2. The load balancer 3 judges whether the request packet received contains a delimiter or not. In this case, the request packet is generated from one packet and therefore contains the delimiter. Hence, the load balancer 3 determines a proper server 4 having a content specified by a URL indicated in the request packet. Then, the load balancer 3 opens the TCP connection with the determined server 4 and forwards the request packet to this server 4. At this time, the load balancer 3 deletes this packet from the packet buffer 8.

The server 4 receives the request packet from the load balancer 3. The server 4 generates a response packet (containing an HTTP response) to the request packet received. Then, the server 4 sends the response packet to the load balancer 3.

The load balancer 3 receives the response packet. The load balancer 3 forwards the received response packet to the client 2. At this time, the load balancer 3 deletes this response packet from the packet buffer 9. Subsequently, the client 2 executes a close phase process.

Secondly, an operation sequence in a case where the HTTP request is structured of one single request packet that is dropped, will be described referring to FIG. 9(b). the open phase and the close phase in the operation sequence of the load sharing system 1 are, however, the same in any case, and therefore the following discussion does not deal with the explanations of the open phase and the close phase.

To begin with, the client 2 sends the request packet to the load balancer 3. The load balancer 3 analyzes a payload in the request packet, thus determines the allocating destination server 4, and opens the TCP connection with the server 4. The load balancer 3 forwards the request packet to the thus determined server 4. At this time, the assumption is that the forwarded request packet is dropped. In this case, the server 4 does not receive the request packet forwarded from the load balancer. Accordingly, the server 4 does send an Ack packet to the request packet back to the load balancer. Therefore, in this case, the client 2 is unable to receive the Ack packet to the request packet from the load balancer 3. The client 2, when it reaches a time-out (waiting till an elapse of time-out seconds), retransmits the request packet to the load balancer 3. Then, the load balancer 3 receives the request packet retransmitted and forwards this request packet to the server 4. The client 2 repeats this operation till the client 2 receives Ack to the request packet transmitted. Then, finally the client 2 receives a response packet from the load balancer 3.

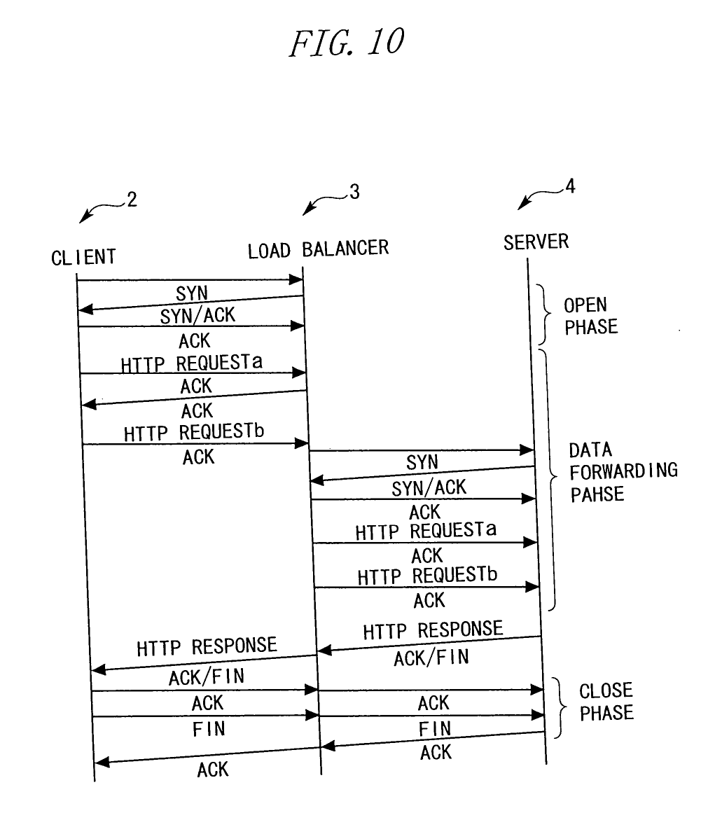

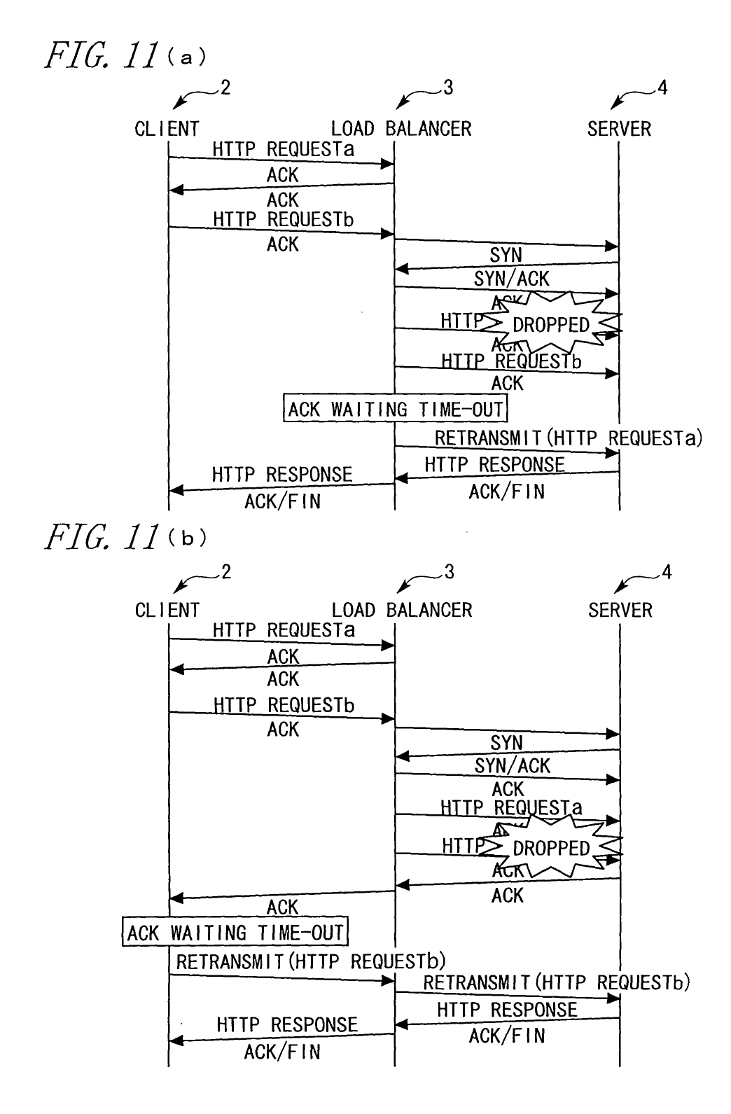

FIGS. 10, 11(a) and 11(b) are diagrams each showing an operation sequence of the load sharing system 1 in a case where the HTTP request is structured of a plurality of request packets. Thirdly, the operation sequence in a case where the HTTP request is structured of the plurality of request packets that is not dropped, will be described referring to FIG. 10.

Herein, a request packet a (containing an HTTP request a) is defined as a request packet containing no delimiter, while a request packet b (containing an HTTP request b) is defined as a request packet containing a delimiter. Namely, the structure is that one HTTP request is separated into the HTTP request a and the HTTP request b. If the HTTP request is structured of three or more request packets, the last request may be conceived as the request packet b, other request packet just anterior thereto may be considered as the request packet a.

The client 2 sends the request packet a to the load balancer 3. The load balancer 3 analyzes a payload in the request packet a, and judges that the request packet a does not contain the delimiter. Hence, the load balancer 3 sends a packet containing Ack (which is called an Ack packet) to the client 2.

The client 2 receives the Ack packet from the load balancer 3. Then, the client 2 sends the request packet b to the load balancer 3. The load balancer 3 analyzes a payload on the request packet b and judges that the payload contains a delimiter. Therefore the load balancer 3 determines the allocating destination server 4 on the basis of the request packet a and the request packet b that have been received previously. Then, the load balancer 3 opens the TCP connection with the determined server 4 and forwards the request packets a and b to the server 4.

The server 4 receives the request packets a, b from the load balancer 3. The server 4 generates a response packet to the request packets received. Subsequently, the server 4 sends the generated response packet to the load balancer 3.

The load balancer 3 acknowledges a receipt of the request packet a by use of an Ack number contained in the response packet. The load balancer 3 forwards the response packet to the client 2.

The client 2 receives the response packet. Then, the client 2 acknowledges the receipt from the response packet received.

Fourthly, the operation sequence in a case where the HTTP request is structured of the plurality of request packets that is dropped, will be described referring to FIG. 11(a). The operation sequence till the stage that the load balancer 3 forwards the request packets a, b to the server 4 is, however, the same as the third operation sequence, and therefore its explanation is omitted.

The assumption is that the request packet a is to be dropped after the load balancer 3 has forwarded the request packets a, b to the server 4. In this case, the server 4 receives not the request packet a but the request packet b. Hence, the server 4 does not send a packet containing Ack to the request packet a.

The load balancer 3 is unable to receive the packet containing Ack to the request packet a from the server 4, and therefore, after the elapse of time-out seconds, resends the request packet a to the server 4. The load balancer 3 repeats this process till it receives the packet containing Ack to the request packet a from the server 4. Finally, the load balancer receives the response packet from the server 4 and forwards this received response packet to the client 2. At this moment, this response packet contains Ack to the request packet a. Therefore, it follows that the load balancer 3 receives the packet containing Ack to the request packet a.

Fifthly, the operation sequence in a case where the HTTP request is structured of the plurality of request packets that is dropped, will be described referring to FIG. 11(b). The operation sequence till the stage that the load balancer 3 forwards the request packets a, b to the server 4 is, however, the same as the third operation sequence, and therefore its explanation is omitted.

The assumption is that the request packet b is to be dropped after the load balancer 3 has forwarded the request packets a, b to the server 4. In this case, the server 4 receives only the request packet a. Therefore, the server 4 sends a packet containing Ack to only the request packet a to the load balancer 3.

The load balancer 3 receives the packet containing Ack to the request packet a. Thereafter, the load balancer 3 forwards the packet containing Ack to the client 2.

The client 2 receives the packet containing Ack to the request packet a. The client 2 has already, however, received the packet containing Ack to the request packet a and therefore executes nothing. Namely, the client 2 has already received the packet containing Ack to the request packet a from the load balancer 3 and therefore executes none of the processes. The client 2 is, however, unable to receive the packet containing Ack to the request packet b. Hence, the client 2, after the elapse of time-out seconds, resends the request packet b to the load balancer 3.

The client 2 repeats this process till it receives the response packet from the load balancer 3. At this time, the response packet contains Ack to the request packet b. Hence, it follows that the client 2 receives the Ack packet from the load balancer 3.

<Operation>

The load balancer 3 in the first embodiment of the present invention, if the HTTP request is structured of one single request packet, does not return Ack to the request packet to the client 2. Accordingly, the load balancer 3 has no necessity of executing the retransmission management about the request packet. It is therefore possible to delete this request packet from the packet buffer 8 at an early stage. Namely, the load balancer 3 can release the storage area on the packet buffer 8 at the early stage.

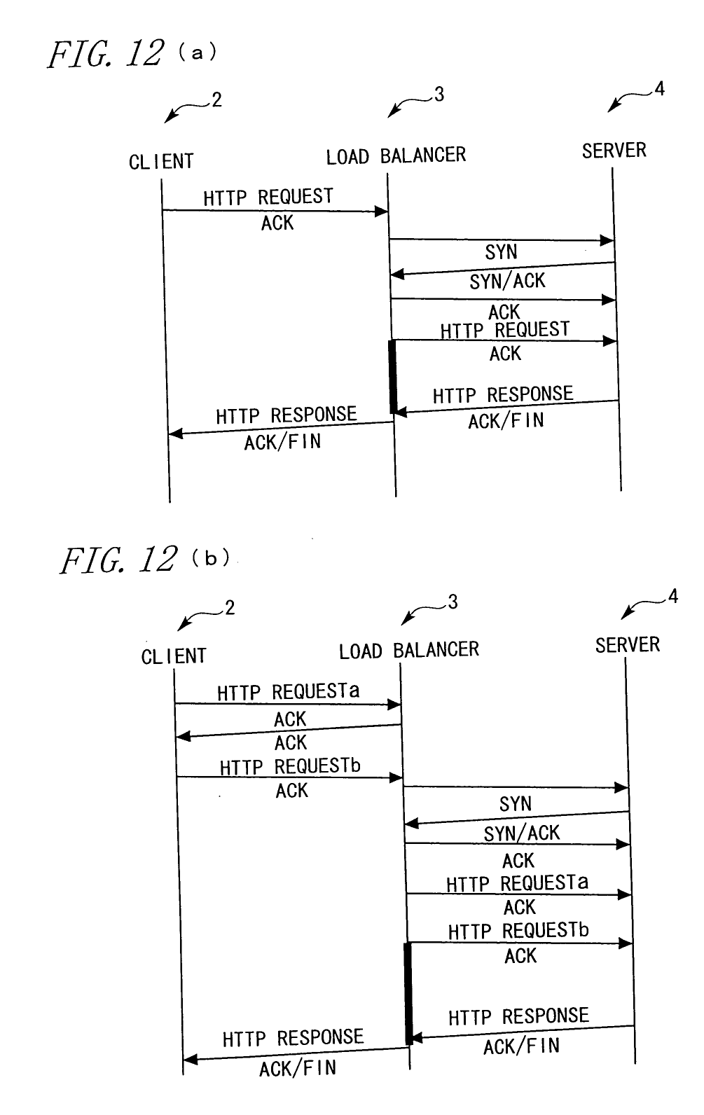

FIG. 12(a) is a diagram showing a timing when the storage area on the packet buffer 8 is released in the case where the HTTP request is structured of one single request packet. The conventional load balancer deletes the request packet from the packet buffer just when receiving Ack to the request packet from the server (when receiving the response packet).

On the other hand, the load balancer 3 deletes the request packet from the packet buffer 8 just when forwarding the request packet to the server 4. A difference in timing is shown by a bold line in FIG. 12(a). Thus, according to the load balancer 3 of the present invention is capable of releasing the storage area on the packet buffer 8 at the early stage.

Moreover, when the HTTP request is structured of the plurality of request packets, the load balancer 3 does not send Ack to the last request packet (containing the delimiter) to the client 2. Hence, the load balancer 3 has no necessity of executing the retransmission management about the last request packet. It is therefore feasible to delete the last request packet from the packet buffer 8 at the early stage. That is, the load balancer 3 can release the storage area on the packet buffer 8 at the early stage.

FIG. 12(b) is a diagram showing a timing when the storage area on the packet buffer 8 is released in the case where the HTTP request is structured of the plurality of request packets. The conventional load balancer deletes the last request packet from the packet buffer just when receiving Ack to the last request packet from the server (when receiving the response packet). The load balancer 3, however, deletes the last request packet from the packet buffer 8 just when forwarding the last request packet to the server 4. A difference in timing is shown by a bold line in FIG. 12(b).

Thus, the load balancer 3 in the first embodiment releases the storage area on the packet buffer 8 at the early stage. Hence, there are improved a multiplexing rate of the session in the load balancer 3, and this is followed by an improvement of a latency in the load balancer 3 and by actualization of decreases in an exothermic quantity, a consumption of electricity and an area for implementation.

<Modified Example>

In the load balancer 3 in the first embodiment of the present invention, the packet buffers 8, 9 are constructed separately and may also be constructed by use of one storage device.

### SECOND EMBODIMENT

<System Architecture>

A load sharing system 1a using a load balancer 3a in a second embodiment will be described. A system architecture of the load sharing system 1a is basically the same as the load sharing system 1 using the load balancer 3 in the first embodiment. To be specific, the load sharing system 1a is configured by use of the plurality of clients 2, the load balancer 3a, the plurality of servers 4, and the network 5 through which the plurality of clients 2 are connected communicably to the load balancer 3a. The client 2 and the server 4 have already been explained in the first embodiment given above, and therefore the following discussion will deal with an architecture of the load balancer 3a.

<<Load Balancer>>

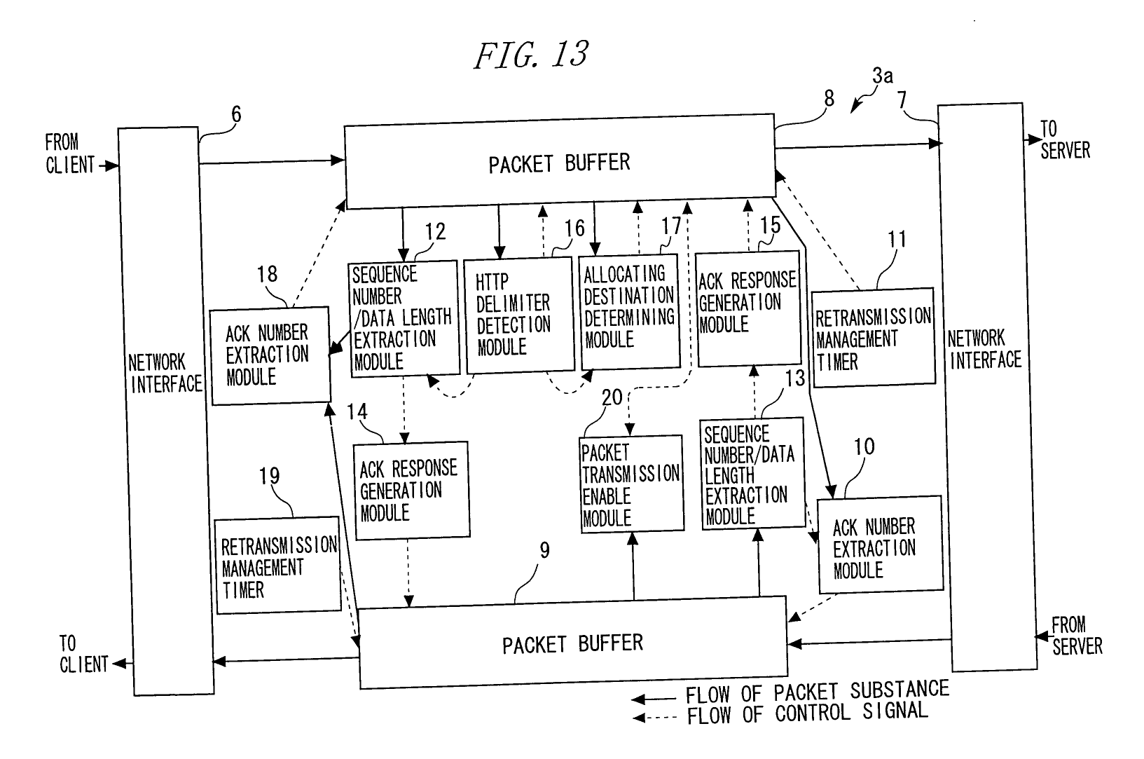

FIG. 13 is a block diagram of the load balancer 3a in the second embodiment of the present invention. The architecture of the load balancer 3a will be explained referring to FIG. 13. The description of the load balancer 3a is, however, focused on only different components from the load balancer 3. The load balancer 3a further includes a packet transmission enable module 20.

The packet transmission enable module 20 is constructed of a CPU, a RAM, etc.. The packet transmission enable module 20 is stored with the sequence number and the data length of the request packet forwarded to the server 4. Further, the packet transmission enable module 20 compares a value of the Ack number of the packet received from the server 4 with a sum of values of the sequence number and the data length. The packet transmission enable module 20, if these two values are coincident with each other, enables the packet buffer 8 to forward a subsequent request packet to the server.

<Operational Example>

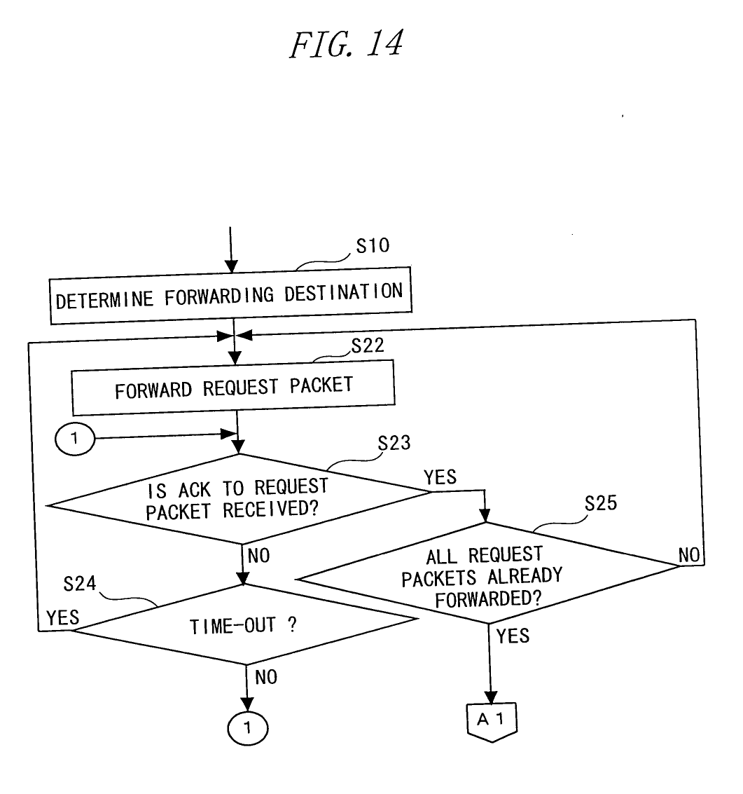

FIG. 14 is a flowchart showing only a different operation from the load balancer 3 in an operational example of the load balancer 3a in the second embodiment. The operational example of the load balancer 3a will be described referring to FIG. 14. The discussion is, however, focused on the different operation from the operation of the load balancer 3.

The allocating destination determining module 17, when determining the server 4 as an allocating destination (S10), forwards a piece of first request packet/a piece of request packet to the determined server 4 (S22). At this time, the packet transmission enable module 20 is stored with the sequence number and the data length of the request packet forwarded.

When the packet containing Ack is buffered in the packet buffer 9, the packet transmission enable module 20 compares a value of the Ack number of this packet with a sum of values of the sequence number and the data length stored in the module 20 itself. If these values are coincident with each other, the packet transmission enable module 20 judges that the packet containing Ack to the forwarded request packet is received (S23).

The packet transmission enable module 20, when judging that the packet containing Ack to the forwarded request packet is not received or that the packet containing Ack is not buffered in the packet buffer 9 (S23-No), the retransmission management timer 11 judges whether the forwarded request packet falls into a time-out or not (S24). In the case of the time-out (S24-Yes), the packet buffer 8, the packet buffer 8 retransmits to the server 4 the request packet judged to be the time-out (S22). Whereas if not judged to be the time-out (S24-No), the load balancer 3a waits till Ack to the forwarded request packet is received.

The packet transmission enable module 20, when judging that the packet containing Ack to the forwarded request packet is received (S23-Yes) m judges whether all the request packets are forwarded or not (S25). If there is a request packet that is not yet forwarded (S25-No), the packet transmission enable module 20 enables the subsequent request packet to be forwarded. While on the other hand, if all the request packets are forwarded (S25-Yes), processes from S12 onward are executed (see FIG. 6).

<Operation Sequence>

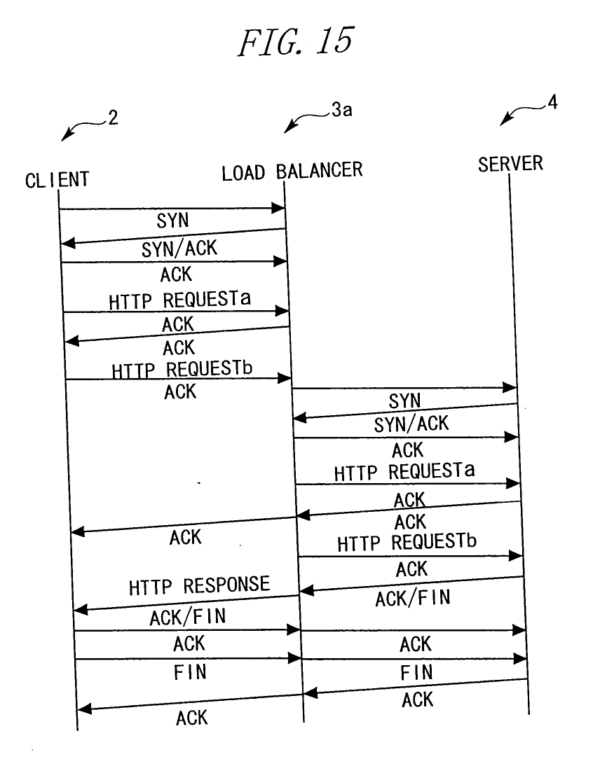

FIG. 15 is a diagram showing an operation sequence of the load sharing system 1a using the load balancer 3a in the second embodiment. The operation sequence of the load sharing system 1a will be explained with reference to FIG. 15. The description will, however, be focused on only the operation sequence different from the operation sequence of the load sharing system 1.

The load balancer 3a, after determining the server 4 as a request packet forwarding destination, forwards the request packet a to the determined server 4. The server 4 receives the request packet a from the load balancer 3a. Then, the server 4 sends to the load balancer 3a the packet containing Ack to the received request packet a.

The load balancer 3a, when receiving the packet containing Ack to the request packet a, forwards this packet to the client 2. Then, the load balancer 3a forwards the subsequent request packet, i.e., the request packet b.

<Operation>

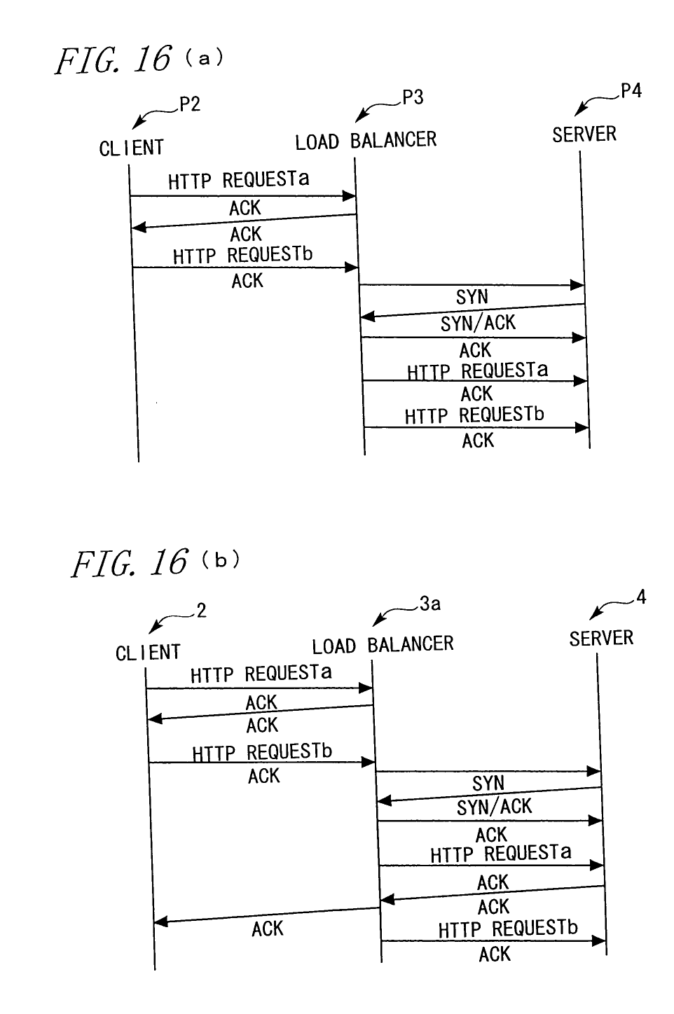

FIGS. 16(a) and 16(b) are diagram showing a difference in operation between the load balancer P3 in the related art in FIG. 16(a) and the load balancer 3a in the second embodiment of the present invention in FIG. 16(b). The operation of the load balancer 3a in the second embodiment of the present invention will be explained referring to FIG. 16(b). The load balancer P3 in the related art, in the case of forwarding to the server P4 the HTTP request structured of the plurality of request packets, consecutively forwards the request packets. Therefore, there might be a case where congestion occurs between the load balancer P3 and the server P4 with the result that the request packet is dropped.

While on the other hand, the load balancer 3a in the second embodiment of the present invention, in the case of forwarding to the server 4 the HTTP request structured of the plurality of request packets, after receiving the packet containing Ack to the request packet forwarded in advance, forwards the subsequent request packet. Consequently, the occurrence of the congestion between the load balancer 3a and the server 4 is prevented. Accordingly, the request packet is prevented from being dropped due to the occurrence of the congestion.

<Modified Example>

The packet transmission enable module 20 may increase exponentially the number of the request packets enabled to be transmitted. Namely, the packet transmission enable module 20 may determine, based on the slow start mechanism, the number of the request packets enabled to be transmitted.

### THIRD EMBODIMENT

<System Architecture>

A load sharing system 1b using a load balancer 3b in a third embodiment will be described. A system architecture of the load sharing system 1b is basically the same as the load sharing system 1 using the load balancer 3 in the first embodiment. Specifically, the load sharing system 1b is configured by use of the plurality of clients 2, the load balancer 3b, the plurality of servers 4, and the network 5 through which the plurality of clients 2 are connected communicably to the load balancer 3b. The client 2 and the server 4 have already been explained in the first embodiment given above, and therefore the following discussion will deal with an architecture of the load balancer 3b.

<<Load Balancer>>

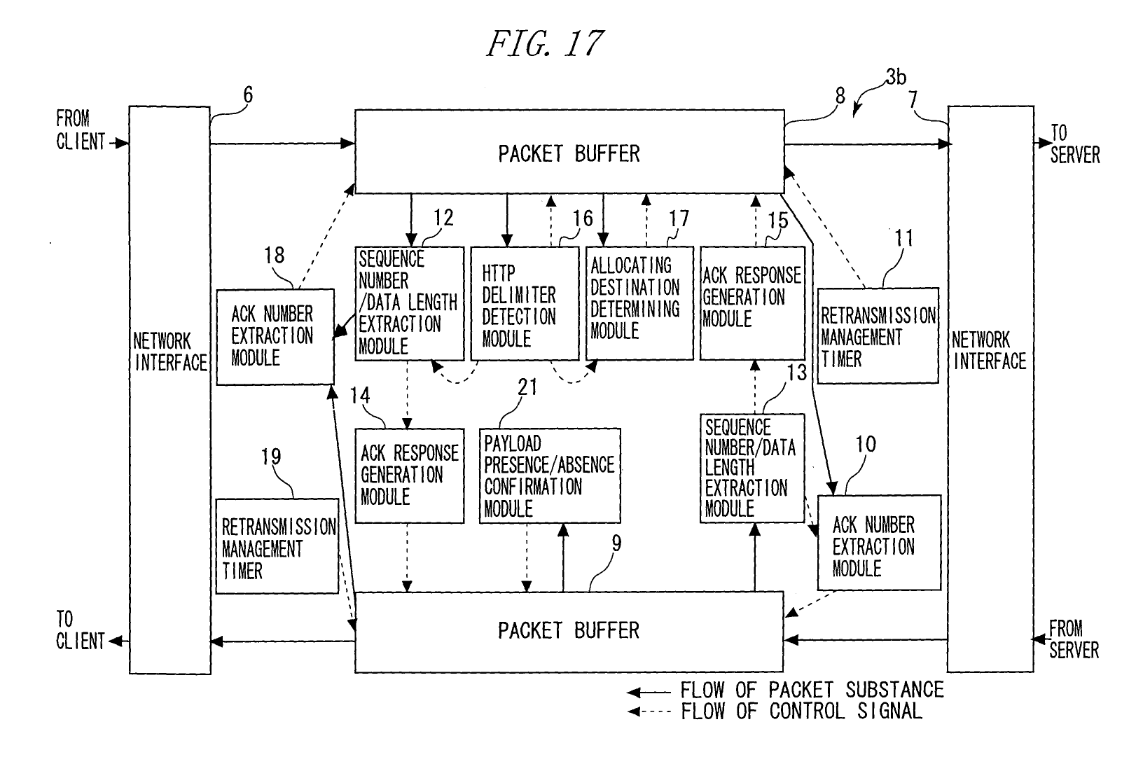

FIG. 17 is a block diagram of the load balancer 3b in the third embodiment of the present invention. The architecture of the load balancer 3b will be explained referring to FIG. 17. The description of the load balancer 3b is, however, focused on only different components from the load balancer 3. The load balancer 3b further includes a payload confirmation module 21.

The payload confirmation module 21 is constructed of a CPU, a RAM, etc.. The payload confirmation module 21 checks whether or not the packet stored on the packet buffer 9 contains a payload. If this packet does not contain the payload, the payload confirmation module 21 gives an instruction to the packet buffer to delete this packet therefrom. Whereas if this packet contains the payload, the payload confirmation module 21 instructs the packet buffer 9 to forward this packet to the client 2.

<Operational Example>

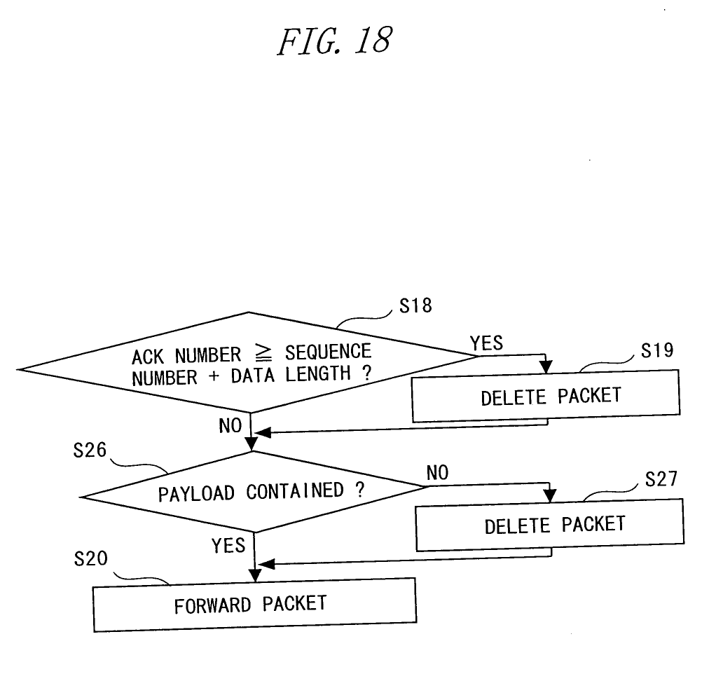

FIG. 18 is a flowchart showing only a different operation from the load balancer 3 in an operational example of the load balancer 3b in the third embodiment. The operational example of the load balancer 3b will be explained with reference to FIG. 18. The explanation is, however, focused on only the different operation from the operation of the load balancer 3.

When receiving a new packet from the server 4, the Ack number extraction module 18 checks whether or not there is a packet having a smaller sum of values of the sequence number and the data length than a value of the Ack number of this packet in the packet buffer 8 (S18). If such a packet is buffered in the packet buffer 8 (S18-Yes), the packet buffer 8 deletes this packet (S19).

Next, the payload confirmation module 21 judges whether or not this packet contains the payload (S26). If this packet does not contain the payload (S26-No), the payload confirmation module 21 gives an instruction to the packet buffer 9 not to forward the packet to the client 2 but to delete this packet. Whereas if this packet contains the payload (S26-Yes), the payload confirmation module 21 instructs the packet buffer 9 to forward this packet to the client 2.

<Operation Sequence>

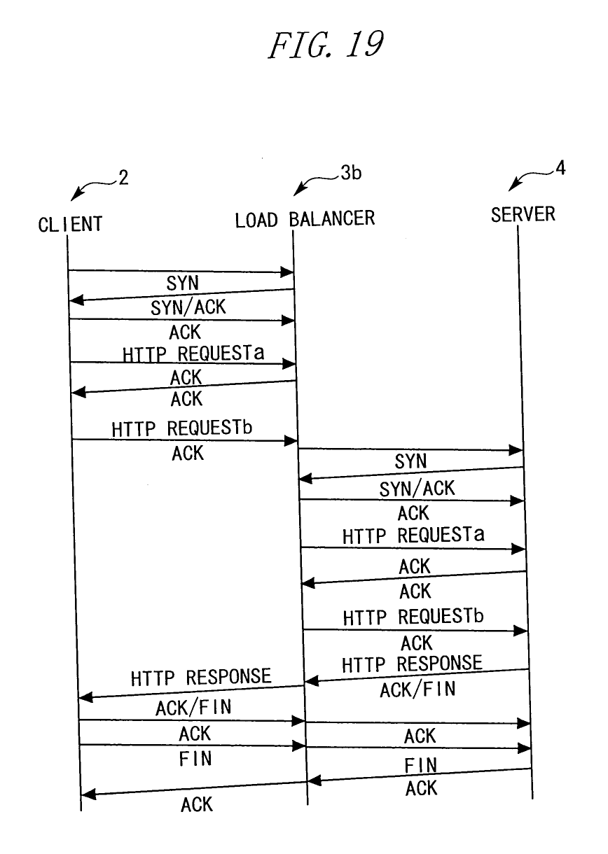

FIG. 19 is a diagram showing an operation sequence of the load sharing system 1b using the load balancer 3b in the third embodiment. The operation sequence of the load sharing system 1b will be described referring to FIG. 19. The description is, however, focused on only an different operation sequence from the operation sequence of the load sharing system 1.

The load balancer 3b forwards the request packets a, b to the server 4. The server 4 sends to the load balancer 3b a packet containing Ack to the request packet a and a packet containing Ack (that is a response packet in this case) to the request packet b. The load balancer 3b, when receiving the packet containing Ack to the request packet a, deletes this Ack packet without forwarding this packet to the client 2. To be specific, the load balancer 3b, when receiving the packet containing no HTTP response, deletes this packet without forwarding this packet to the client 2. By contrast, the load balancer 3b, when receiving the response packet, forwards this response packet to the client 2.

<Operation>

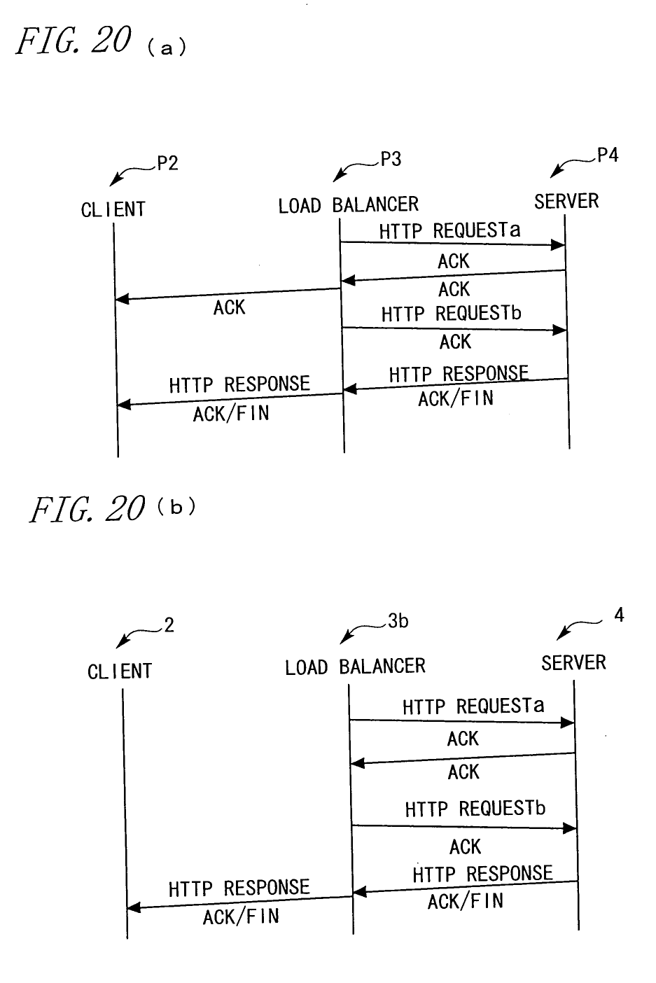

FIG. 20 is a diagram showing a difference in operation between the load balancer P3 in the related art and the load balancer 3b in the third embodiment of the present invention. The operation of the load balancer 3b in the third embodiment of the present invention will be explained referring to FIG. 20. The load balancer P3 in the related art forwards all the packets received from the server P4 to the client P2. Hence, the load balancer P3 in the related art forwards to the client P2 the packet containing no HTTP response (which is the packet for sending Ack in this case), i.e., the packet having no necessity of being forwarded to the client P2. Therefore, the bandwidth of the network for connecting the load balancer P3 to the client P2 is unnecessarily used.

By contrast, the load balancer 3b in the third embodiment of the present invention deletes the packet containing no HTTP response, i.e., no payload without forwarding this packet to the client 2. Therefore the bandwidth of the network 5 is not used with a futility.

<Modified Example>

The payload confirmation module 21 may be applied to the load balancer 3a in the second embodiment of the present invention. The load balancer 3a in the second embodiment of the present invention invariably receives the packet containing Ack from the server 4 at an interval between the transfer of the request packet a and the transfer of the request packet b. At this time, the scheme of applying the payload confirmation module 21 eliminates the operation of sending this packet to the client 2. It is therefore feasible to save the bandwidth of the network 5.

What is claimed is:

1. A load balancer comprising:
a judging module judging based on a content of data received from a client whether or not an acknowledgement of the data is to be sent to the client;
an acknowledging module sending the acknowledgement to the client in accordance with a result of the judgment by said judging module;
a forwarding module forwarding the data received from the client to any of a plurality of servers; and
a retransmission data storage module storing only the data the acknowledgement of which is sent to the client among data forwarded to the server in preparation for a retransmission to the server.

2. A load balancer according to claim 1, wherein said judging module judges, if the data received from the client does not contain a delimiter, that the acknowledgement is sent to the client and judges, if the data contains the delimiter, that the acknowledgement is not set to the client.

3. A load balancer according to claim 1 or 2, further comprising an acknowledgement judging module enabling next data to be forwarded to the server when receiving from the server an acknowledgement to the data forwarded finally to the server in the case of forwarding consecutive data to the server.

4. A load balancer according to any one of claims 1 through 3, further comprising a forwarding-judging module judging whether or not the data received from the server should be forwarded to the client.

5. A load balancer according to claim 4, wherein said forwarding judging module judges, if the data received from the server is structured of only data for the acknowledgement, that the data should not be forwarded.

6. A load balancer according to claim 1, wherein said judging module judges, if the data received from the client is an HTTP request structured of one packet, that the acknowledgement is not sent.

7. A load balancer according to claim 1 or 2, wherein said judging module judges, if the data received from the client is an HTTP request structured of a plurality of packets, that the acknowledgements are sent when receiving packets except for the last packet that structures this HTTP request.
